(19) United States
(12) Patent Application Publication
(10) Pub. No.: US 2025/0040759 A1
(43) Pub. Date: Feb. 6, 2025

(54) FRYING PAN

(71) Applicants: James Thaxton, Humble, TX (US); Aleithea Thaxton, Humble, TX (US)

(72) Inventors: James Thaxton, Humble, TX (US); Aleithea Thaxton, Humble, TX (US)

(21) Appl. No.: 18/229,870

(22) Filed: Aug. 3, 2023

(51) Int. Cl. A47J 37/10; A47J 45/06

(52) U.S. Cl. CPC A47J 37/106; A47J 45/061

(57) ABSTRACT

A frying pan for basting food without tilting the frying pan includes a base which defines a reservoir therein and has an interior edge on an upper surface of the base which defines an opening to the reservoir. The reservoir is positioned adjacent to a first end of the base and is angled downwardly from a second end of the base opposite the first end to the reservoir. The reservoir is configured to hold a basting fluid and has a size such that the reservoir is configured to permit a spoon therein to collect a portion of the basting fluid. A perimeter wall is coupled to and extends upwardly from the base.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to frying pans and more particularly pertains to a new frying pan for basting food without tilting the frying pan.

### (2) Description of Related Art Including Information Disclosed Under 37 CFR 1.97 and 1.98

The prior art describes myriad frying pans for draining fat and other cooking fluids from food when cooking on a stove or other heating element. But the prior art fails to disclose a frying pan which collects run-off cooking fluids from the food into a reservoir which is sized to allow a spoon to collect the fluid for basting the food. Such a frying pan would be advantageous over the prior art because it facilitates basting food held in the frying pan without tilting the frying pan to pool the fluid in an edge of the pan. By eliminating the need to tilt the frying pan, the risk of burns from spilling the basting fluid or contacting hot portions of the frying pan is minimized. It may also free up a hand of a user to perform other tasks.

### BRIEF SUMMARY OF THE INVENTION

An embodiment of the disclosure meets the needs presented above by generally comprising a base which defines a reservoir therein and has an interior edge on an upper surface of the base which defines an opening to the reservoir. The reservoir is positioned adjacent to a first end of the base and is angled downwardly from a second end of the base opposite the first end to the reservoir. The reservoir is configured to hold a basting fluid and has a size such that the reservoir is configured to permit a spoon therein to collect a portion of the basting fluid. A perimeter wall is coupled to and extends upwardly from the base.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a frying pan according to an embodiment of the disclosure.

FIG. 2 is a bottom perspective view of an embodiment of the disclosure.

FIG. 3 is a top view of an embodiment of the disclosure.

FIG. 4 is a cross-section view of an embodiment of the disclosure taken from Arrows 4-4 in FIG. 3.

FIG. 5 is an in-use view of an embodiment of the disclosure.

FIG. 6 is a top perspective view of an embodiment of the disclosure.

FIG. 7 is a bottom perspective view of an embodiment of the disclosure.

### DETAILED DESCRIPTION OF THE INVENTION

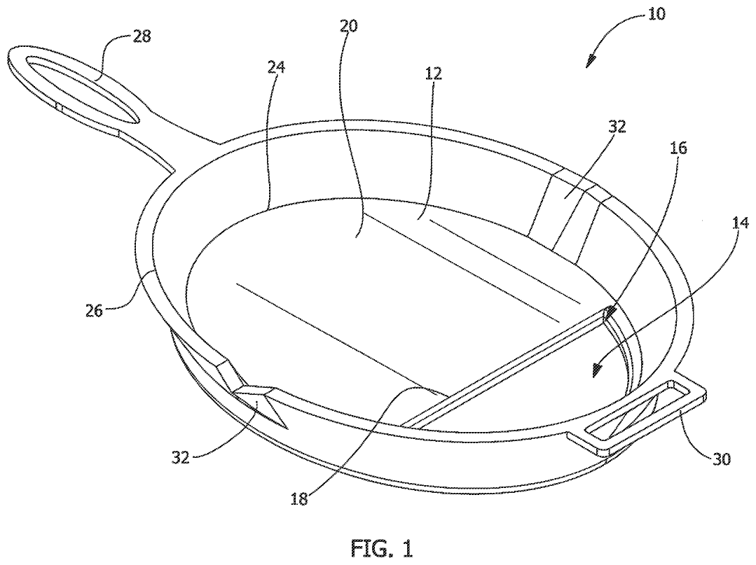

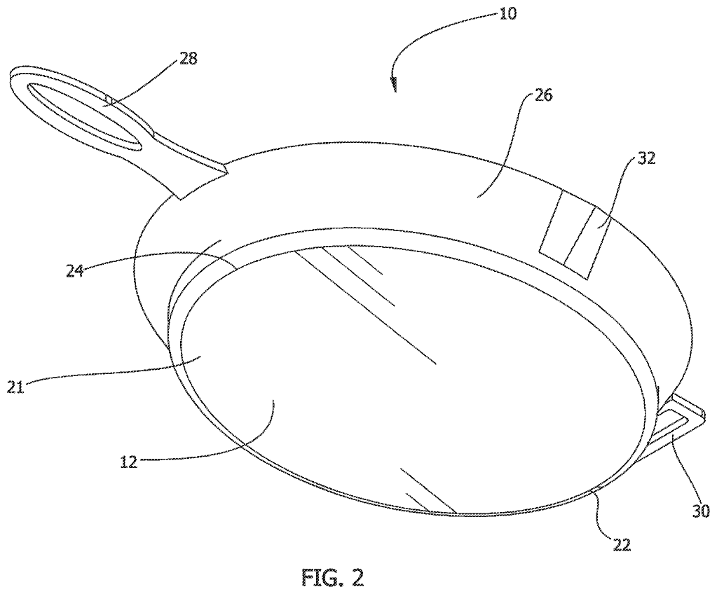

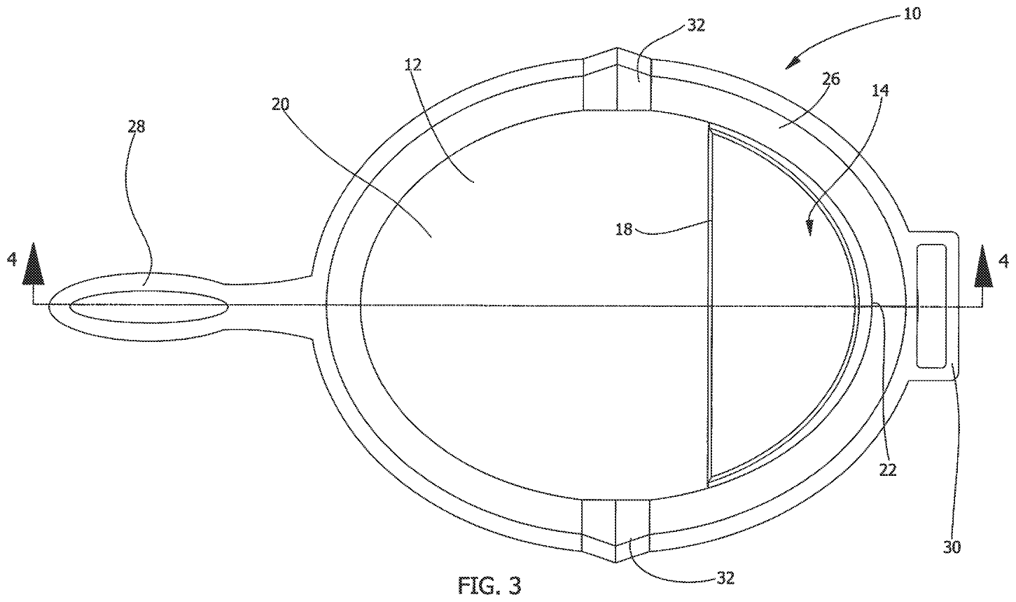

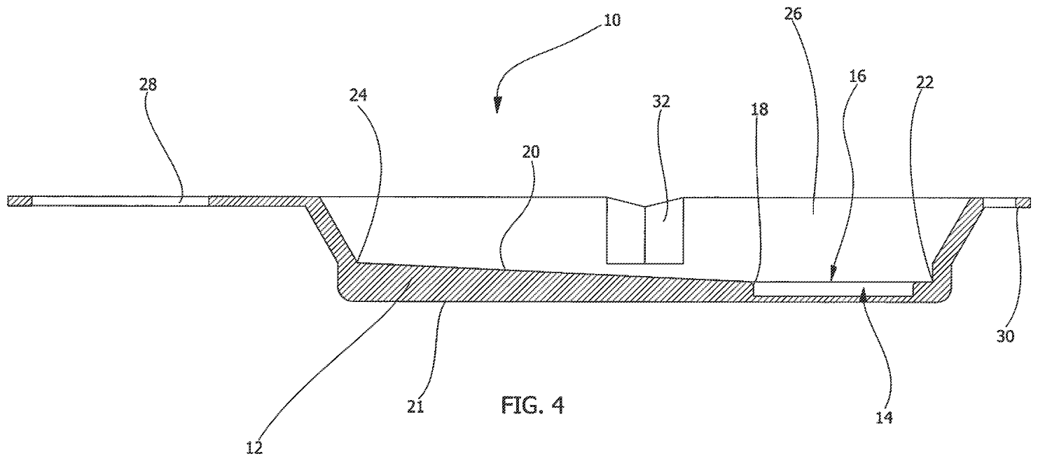

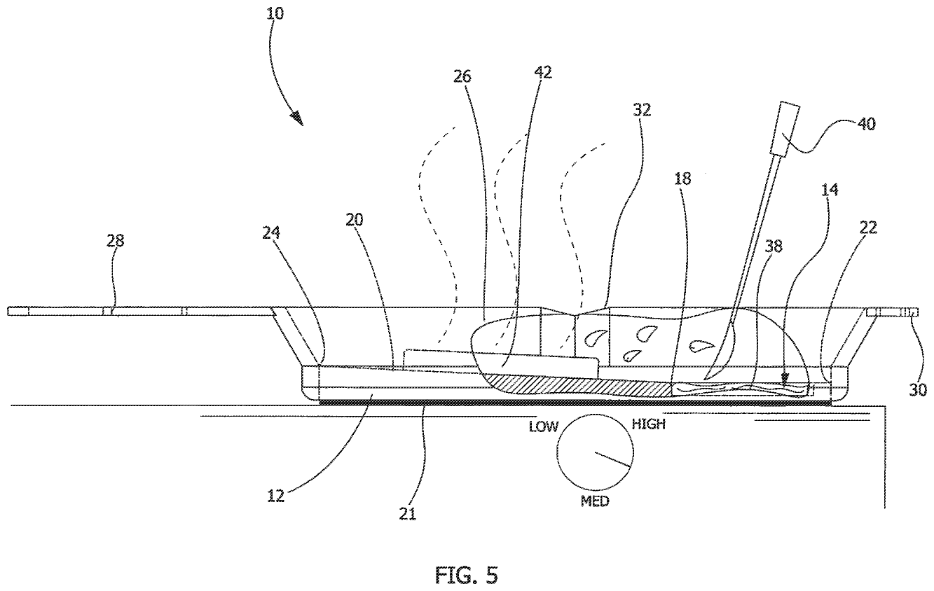

With reference now to the drawings, and in particular to FIGS. 1 through 7 thereof, a new frying pan embodying the principles and concepts of an embodiment of the disclosure and generally designated by the reference numeral 10 will be described.

As best illustrated in FIGS. 1 through 5, the frying pan 10 generally comprises a base 12 which base 12 defines a reservoir 14 therein and has an interior edge 18 on an upper surface 20 thereof defining an opening 16 to the reservoir 14. The reservoir 14 is positioned adjacent to a first end 22 of the base 12, and the upper surface 20 is angled downwardly from a second end 24 of the base 12 opposite the first end 22 to the reservoir 14. The reservoir 14 is configured to hold a basting fluid 38. The reservoir 14 has a size such that the reservoir 14 is configured to permit a spoon 40 therein to collect a portion of the basting fluid 38. An area of the opening 16 is at least 25% of a surface area of the upper surface 20. The upper surface 20 of the base 12 has an elliptical shape, wherein a major axis of the elliptical shape extends between the first end 22 and the second end 24 of the base 12. A perimeter wall 26 is coupled to and extending upwardly from the base 12.

An elongated handle 28 is coupled to the perimeter wall 26 above the second end 24 of the base 12 and extends away from the perimeter wall 26. A U-shaped handle 30 is coupled to the perimeter wall 26 above the first end 22 of the base 12. A pair of pour spouts 32 is formed in the perimeter wall 26, and the pour spouts 32 are positioned opposite each other. The base 12, the perimeter wall 26, the elongated handle 28, the U-shaped handle 30, and the pair of pour spouts 32 are integrally formed with each other.

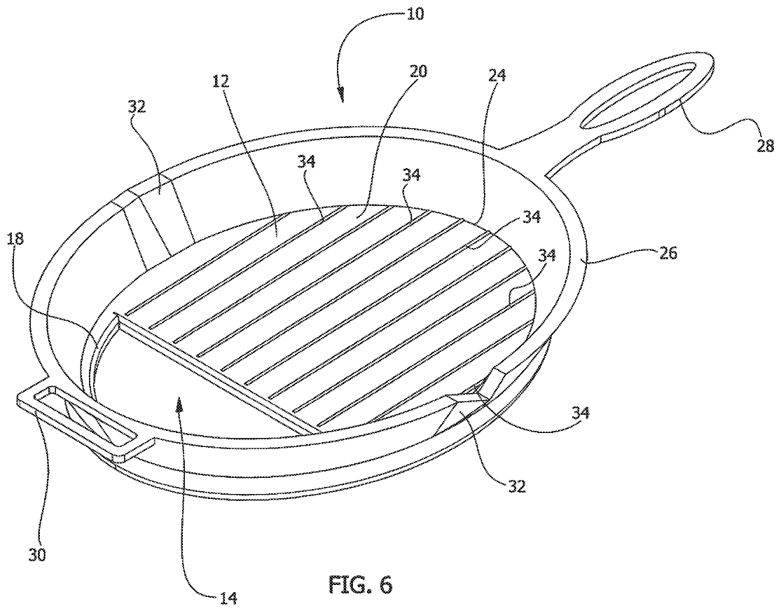

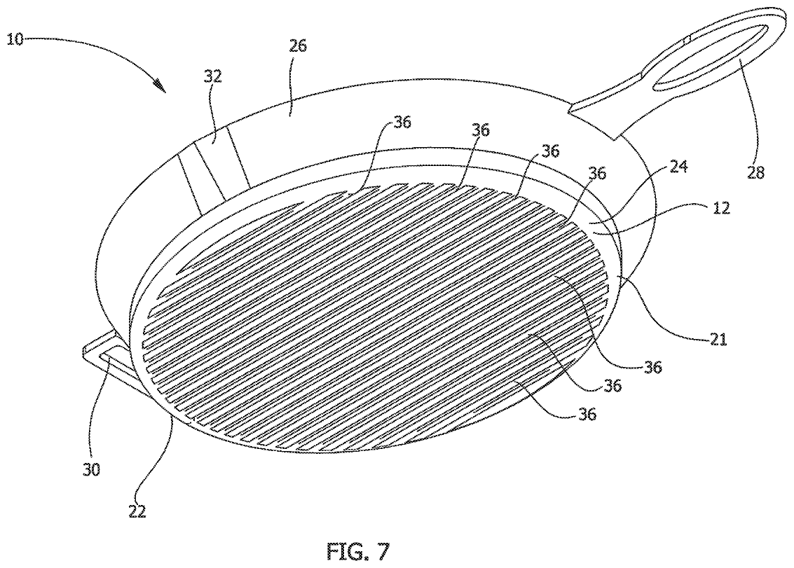

FIGS. 6 and 7 depict an alternative embodiment which additionally includes a plurality of grill ribs 34 coupled to the upper surface 20 of the base 12. Each grill rib 34 of the plurality of grill ribs 34 extends from the first end 22 of the base 12 to the reservoir 14. A plurality of bottom ribs 36 is also coupled to a bottom surface 21 of the base 12 and serves to increase the surface area of a bottom of the frying pan 10 to increase the rate of heat transfer from a heating element below the frying pan 10 to the upper surface 20 of the base 12.

In use, the frying pan 10 is heated on a stove or other heating element. Food 42 is added to the frying pan 10 to be cooked. Basting fluid 38, which may contain cooking liquids, run-off fats from the food 42, will be guided by the upper surface 20 into the reservoir 14. The spoon 40 may be used to collect basting fluid 38 from the reservoir 14 and deposit them onto the food 42 without needing to tilt the frying pan 10. The elongated handle 28 is positioned on an opposite end of the base 12 from the reservoir 14 to facilitate gripping the frying pan 10 via the elongated handle 28 with one hand while basting with the spoon 40 in another hand. In embodiments with the grill ribs 34, the grill ribs 34 also facilitate directing the basting fluid 38 from the upper surface 20 of the base 12 into the reservoir 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A frying pan comprising:
a base, the base defining a reservoir therein, the base having an interior edge on an upper surface of the base which defines an opening to the reservoir, the reservoir being positioned adjacent to a first end of the base, the upper surface being angled downwardly from a second end of the base opposite the first end to the reservoir, the reservoir being configured to hold a basting fluid, the reservoir having a size such that the reservoir is configured to permit a spoon therein to collect a portion of the basting fluid; and
a perimeter wall being coupled to and extending upwardly from the base.

2. The frying pan of claim 1, wherein an area of the opening being at least 25% of a surface area of the upper surface.

3. The frying pan of claim 1, wherein the upper surface of the base has an elliptical shape, a major axis of the elliptical shape extending between the first end and the second end of the base.

4. The frying pan of claim 1, further comprising an elongated handle being coupled to the perimeter wall above the second end of the base, the elongated handle extending away from the perimeter wall.

5. The frying pan of claim 4, further comprising a U-shaped handle being coupled to the perimeter wall above the first end of the base.

6. The frying pan of claim 1, further comprising a pair of pour spouts being formed in the perimeter wall, the pair of pour spouts being positioned opposite each other.

7. The frying pan of claim 1, further comprising a plurality of grill ribs being coupled to the upper surface of the base, the plurality of grill ribs extending from the first end of the base to the reservoir.

8. The frying pan of claim 1, further comprising a plurality of bottom ribs being coupled to a bottom surface of the base.

9. A frying pan comprising:
a base, the base defining a reservoir therein, the base having an interior edge on an upper surface of the base which defines an opening to the reservoir, the reservoir being positioned adjacent to a first end of the base, the upper surface being angled downwardly from a second end of the base opposite the first end to the reservoir, the reservoir being configured to hold a basting fluid, the reservoir having a size such that the reservoir is configured to permit a spoon therein to collect a portion of the basting fluid, an area of the opening being at least 25% of a surface area of the upper surface, the upper surface of the base having an elliptical shape, a major axis of the elliptical shape extending between the first end and the second end of the base;
a perimeter wall being coupled to and extending upwardly from the base;
an elongated handle being coupled to the perimeter wall above the second end of the base, the elongated handle extending away from the perimeter wall;
a U-shaped handle being coupled to the perimeter wall above the first end of the base; and
a pair of pour spouts being formed in the perimeter wall, the pair of pour spouts being positioned opposite each other;
wherein the base, the perimeter wall, the elongated handle, the U-shaped handle, and the pair of pour spouts are integrally formed with each other.

10. The frying pan of claim 9, further comprising:
a plurality of grill ribs being coupled to the upper surface of the base, the plurality of grill ribs extending from the first end of the base to the reservoir; and
a plurality of bottom ribs being coupled to a bottom surface of the base.
